(19) United States
(12) Patent Application Publication
(10) Pub. No.: US 2011/0226144 A1
(43) Pub. Date: Sep. 22, 2011

(54) DIAMOND-COATED DOCTOR BLADE

(75) Inventors: Hans Jörg Brudermann, Zollikofen (CH); Sibylle Stiltz, Lotzwil (CH); Andreas Hugli, Heimiswil (CH)

(73) Assignee: DAETWYLER SWISSTEC AG, Bleienbach (CH)

(21) Appl. No.: 13/121,764

(22) PCT Filed: Sep. 10, 2009
(86) PCT No.: PCT/CH2009/000303

§ 371 Date: Jun. 7, 2011

(30) Foreign Application Priority Data
Oct. 7, 2008 (CH) 1592/08

(51) Int. Cl. B41F 31/20; B05D 1/36; B05D 3/02; B05D 1/18

(52) U.S. Cl. 101/350.6; 427/402; 427/372.2; 427/435

(57) ABSTRACT

A doctor blade for wiping printing ink off a surface of a printing plate and/or for use as a paper doctor knife, has a flat and elongated main body including a working edge region configured in a longitudinal direction, wherein at least the working edge region is covered with a first coating on the basis of a nickel-phosphorus alloy. The doctor blade is characterized in that monocrystalline and/or polycrystalline diamond particles are dispersed in the first coating, wherein a particle sizes of the diamond particles measure at least 5 nm and less than 50 nm.

### CROSS-REFERENCE TO RELATED APPLICATIONS

This application claims priority to PCT Application No. PCT/CH2009/000303 filed Sep. 18, 2009, and to Swiss Application No. CH1592/08 filed Oct. 7, 2008, which applications are incorporated herein by reference and made a part hereof.

### BACKGROUND OF THE INVENTION

1. Field of the Invention

The invention relates to a doctor blade, in particular for doctoring off printing ink from a surface of a printing form and/or for use as a paper doctor knife, comprising a flat and elongated main body having a working edge region formed in a longitudinal direction, wherein at least the working edge region is covered with a first coating on the basis of a nickel-phosphorus alloy. Furthermore, the invention relates to a process for producing a doctor blade and also to the use thereof.

2. Description of the Related Art

In the printing industry, doctor blades are used, in particular, for wiping excess printing ink off the surfaces of printing cylinders and printing rolls. Particularly in the case of gravure printing and flexographic printing, the quality of the doctor blade has a decisive influence on the printing result. By way of example, instances of unevenness or irregularities in the working edges of the doctor blade that are in contact with the printing cylinder lead to incomplete wiping of the printing ink off the webs of the printing cylinders. This can result in uncontrolled release of printing ink on the printing substrate.

During the wiping-off operation, the working edge regions of the doctor blade are pressed onto the surfaces of the printing cylinders or printing rolls and are moved in relation thereto. Particularly in the case of rotary printing presses, the working edges are therefore subjected to high mechanical stresses, which are associated with corresponding wear. In principle, doctor blades are therefore consumable items, which have to be exchanged periodically.

Doctor blades are usually formed on the basis of a steel main body with a specially shaped working edge or working edge region. In order to improve the service life of the doctor blade, it is possible for the working edges of the doctor blade to additionally be provided with coatings or coverings made of metals and/or plastics. Metallic coatings often contain nickel or chromium which, if appropriate, are present in a form mixed or alloyed with other atoms and/or compounds. In this respect, the material properties of the coatings have a significant influence on the mechanical and tribological properties of the doctor blade, in particular.

WO 2003/064157 (Nihon New Chrome Co. Ltd.), which is equivalent to U.S. Pat. No. 7,152,526, describes, for example, doctor blades for the printing sector, which have a first layer of chemical nickel with hard material particles dispersed therein and a second layer with low surface energy. The second layer preferably consists of a covering made of chemical nickel with fluorine-based resin particles or of a purely organic resin.

Although doctor blades coated in this way have an improved wear resistance compared to uncoated doctor blades, the service life is still not entirely satisfactory. In addition, it has been found that uncontrolled streaking can arise, in particular in the run-in phase, when such doctor blades are used, and this is likewise undesirable.

Therefore, there is still a need for an improved doctor blade which, in particular, has a longer service life and, at the same time, makes optimum wiping off possible.

### SUMMARY OF THE INVENTION

It is an object of one embodiment of the invention to provide a doctor blade belonging to the technical field mentioned in the introduction, which has an improved wear resistance and makes accurate wiping off, in particular of printing ink, possible throughout its service life.

The object is achieved by a device comprising a flat and elongated main body having a working edge region formed in a longitudinal direction, wherein at least the working edge region is covered with a first coating on the basis of a nickel-phosphorus alloy, whereas monocrystalline and/or polycrystalline diamond particles are dispersed in the first coating, wherein the particle size of the diamond particles measures at least 5 nm and less than 50 nm. According to the invention, monocrystalline and/or polycrystalline diamond particles are dispersed in the first coating, wherein the particle size of the diamond particles measures at least 5 nm and less than 50 nm.

In this context, a nickel-phosphorus alloy, which forms the basis of the first coating, is understood to mean a mixture of nickel and phosphorus in which the phosphorus content of the alloy is, in particular, 1-15% by weight. In particular, such alloys can be deposited electrolessly and are thus also referred to as chemical nickel. The expression “on the basis of a nickel-phosphorus alloy” means that the nickel-phosphorus alloy forms the main constituent part of the first coating. In this case, it is also possible by all means for the first coating to contain other types of atom and/or chemical compounds in addition to the nickel-phosphorus alloy, which are present in a smaller proportion than the nickel-phosphorus alloy. The nickel-phosphorus alloy and the other types of atom and/or chemical compounds which may be present form a matrix for the monocrystalline and/or polycrystalline diamond particles. The proportion of the nickel-phosphorus alloy in the matrix is preferably at least 50% by weight, particularly preferably at least 75% by weight and very particularly preferably at least 95% by weight. It is particularly advantageous that, apart from unavoidable impurities, the matrix of the first coating consists exclusively of a nickel-phosphorus alloy. Ideally, apart from unavoidable impurities, the first coating accordingly consists exclusively of a nickel-phosphorus alloy with monocrystalline and/or polycrystalline diamond particles dispersed therein.

According to one embodiment of the invention, the monocrystalline and/or polycrystalline diamond particles are dispersed in the first coating. This means, in particular, that the diamond particles are present in the first coating in a substantially uniformly distributed manner.

In this context, the particle size is understood to mean, in particular, a maximum dimension and/or outer dimension of the monocrystalline and/or polycrystalline diamond particles. With regard to the particle size, the diamond particles generally additionally have a certain distribution or a spread. Therefore, diamond particles having different particle sizes are present, in particular, in the first coating at the same time.

It has been found that the monocrystalline and/or polycrystalline diamond particles, which are dispersed in the first coating on the basis of a nickel-phosphorus alloy and have the particle sizes according to the invention of at least 5 nm and less than 50 nm, significantly improve the wear resistance of the working edges or working edge regions of the doctor blade. This entails, in particular, a long service life of the doctor blade according to one embodiment of the invention.

At the same time, the working edges are optimally stabilized by the first coating on the basis of a nickel-phosphorus alloy with the diamond particles dispersed therein. A sharply defined contact zone is therefore provided between the doctor blade and the printing cylinder or the printing roll, and this in turn makes it possible in particular to wipe off or doctor off printing ink extremely accurately. In this case, the contact zone remains largely stable throughout the service life of the doctor blade or throughout the printing process.

Furthermore, the doctor blades according to one embodiment of the invention have extremely favorable sliding properties on the printing cylinders or printing rolls that are usually used. This also reduces wear to the printing cylinders or printing rolls when the doctor blade according to the invention is used for doctoring off.

In order to improve the wear resistance and optimally stabilize the working edges of the doctor blade, monocrystalline and/or polycrystalline diamond particles having a particle size of at least 5 nm and less than 50 nm have proved to be the ideal choice. In this respect, diamond having a monocrystalline and/or polycrystalline structure has proved to be the ideal material for the particles according to the invention, in particular owing to its high hardness and its chemical inertness to a large number of potential reaction partners. In this case, diamond having a monocrystalline and/or polycrystalline structure is not to be confused with other forms of carbon, e.g., graphite, glassy carbon, graphene, carbon black or amorphous diamond-like carbon (DLC). These forms of carbon only entail the advantages according to the invention to a limited extent, if at all.

In the case of the particle sizes according to one embodiment of the invention, the proportion of the particle surface in relation to the particle volume is very high compared to particle sizes in the micrometer range. Accordingly, the particle surface, which is additionally in contact and interacts with the surrounding nickel-phosphorus alloy, has an insignificant influence on the properties of the diamond particles, and it is evident that this has a positive effect on the properties of the doctor blade according to the invention.

When diamond particles having particle sizes of less than 5 nm are used, the wear resistance of the working edge of the doctor blade, in particular, is reduced, as a result of which the service life of the doctor blade is shortened. In the case of particle sizes of 50 nm and greater, the stabilization of the working edge of the doctor blade, in particular, is reduced, and this impairs the exact wiping off of printing ink.

In combination with nickel-phosphorus alloys, the addition of diamond particles having a particle size of at least 5 nm and less than 50 nm therefore produces novel coatings for doctor blades with superior mechanical and tribological properties.

The phosphorus content of the nickel-phosphorus alloy is preferably 7-12% by weight. In combination with the monocrystalline and/or polycrystalline diamond particles according to the invention, such coatings have proved to be particularly suitable, since a higher wear resistance is thereby obtained, in particular, throughout the service life of the doctor blade. A phosphorus content of 7-12% by weight additionally improves the corrosion resistance, the tarnishing resistance and the inertness of the nickel-phosphorus alloy. A phosphorus content of 7-12% by weight likewise has a positive effect on the sliding properties of the doctor blade and also the stability of the working edge, as a result of which it is possible to wipe off or doctor off printing ink in a particularly exact manner. Furthermore, given a phosphorus content of 7-12% by weight, good adhesion is provided to the main bodies which are usually used for doctor blades, e.g., steel main bodies.

In principle, however, it is also possible to provide a phosphorus content of less than 7% by weight or a phosphorus content of more than 12% by weight, but the positive effects mentioned above are thereby reduced or are even cancelled entirely.

The layer thickness of the first coating is advantageously 1-10 μm. Such thicknesses of the first coating afford optimum protection of the working edge of the doctor blade. In addition, first coatings provided with such dimensions have a high inherent stability, which effectively reduces the partial or complete delamination of the first coating, for example, when doctoring printing ink off a printing cylinder.

Although thicknesses of less than 1 μm are possible, the wear resistance of the working edge or of the doctor blade is reduced rapidly in this case. Thicknesses of more than 10 μm are also feasible, but these are less economical and sometimes have a negative influence on the quality of the working edge.

In particular, the volume density of the monocrystalline and/or polycrystalline diamond particles in the first coating is 5-20%, particularly preferably 15-20%. Doctor blades with such volume densities have an extremely good wear resistance and a long service life. At the same time, an ideally sharply defined contact zone between the doctor blade and the printing cylinder or printing roll is also produced, with the contact zone remaining substantially constant or stable throughout the service life of the doctor blade.

In principle, it is also possible to provide monocrystalline and/or polycrystalline diamond particles with larger or smaller volume proportions. In this case, however, the wear resistance and/or the stability of the doctor blade is impaired in certain circumstances during the printing process.

In a further advantageous embodiment, additional hard material particles are present in the first coating. In this context, the term “hard material particles” is understood to mean, in particular, metal carbides, metal nitrides, ceramics and intermetallic phases, which preferably have a hardness of at least 1000 HV. These include, by way of example, cubic boron nitride (BN), boron carbide (BC), chromium oxide (Cr₂O₃), titanium diboride (TiB₂), zirconium nitride (ZrN), zirconium carbide (ZrC), titanium carbide (TiC), silicon carbide (SiC), titanium nitride (TiN), aluminum oxide or corundum (Al₂O₃), tungsten carbide (WC), vanadium carbide (VC), tantalum carbide (TaC), zirconium dioxide (ZrO₂) and/or silicon nitride (Si₃N₄).

If additional hard material particles are present in the first coating, it is possible, in particular, for the wear resistance of the working edge to be improved further. Ideally, the additional hard material particles comprise aluminum oxide particles or particles of corundum (Al₂O₃) having a particle size of 0.3-0.5 μm. Such hard material particles are distinguished in particular by their hardness, mechanical strength, chemical resistance and good sliding properties. The aluminum oxide particles, in particular having a particle size of 0.3-0.5 μm, further increase the stability of the first coating or of the nickel-phosphorus alloy in combination with the monocrystalline and/or polycrystalline diamond particles, and this improves the quality of the working edge and makes particularly uniform and exact doctoring off possible throughout the service life of the doctor blade.

In principle, however, it is also possible to use hard material particles other than particles of aluminum oxide and/or to provide particle sizes of less than 0.3 μm and/or more than 0.5 μm, but in certain circumstances this is at the expense of the wear resistance and/or stability of the doctor blade. Whether and which type of additional hard material particles are added to the first coating can also depend on the intended use of the doctor blade and is also determined, for example, by the material and the surface quality of the printing cylinders and/or printing rolls.

In a further advantageous variant, a second coating on the basis of a further nickel-phosphorus alloy is arranged on the first coating. A second coating on the basis of a further nickel-phosphorus alloy may serve, in particular, as a protective layer for the first coating, as a result of which the wear resistance and stability of the working edge of the doctor blade can be increased further. A second coating can additionally serve as a stable matrix for further additives which have a positive influence on the doctoring-off operation using the doctor blade according to the invention.

The phosphorus content of the further nickel-phosphorus alloy of the second coating is advantageously less than the phosphorus content of the nickel-phosphorus alloy of the first coating. The combination of coatings with different phosphorus contents provides, in particular, greater protection of the working edge against wear, and at the same time the working edge is stabilized further. A phosphorus content of the further nickel-phosphorus alloy of the second coating of 6-9% by weight has proved to be particularly suitable in this respect.

In principle, however, the phosphorus content of the further nickel-phosphorus alloy of the second coating can also be less than 6% or more than 9%. In principle, it is likewise possible to provide a comparable phosphorus content in the first coating and in the second coating or to form a higher phosphorus content in the second coating than in the first coating. However, this may be at the expense of the quality of the working edge of the doctor blade.

In particular, the layer thickness of the second coating measures 0.5-3 μm. In particular, such layer thicknesses guarantee a high inherent stability of the second coating and, at the same time, a good protective effect for the first coating, and this benefits the stability of the working edge as a whole.

However, it also lies within the scope of the invention to provide a second coating having a layer thickness of less than 0.5 μm or more than 3 μm. However, in certain circumstances, this reduces the stability and wear resistance of the working edge of the doctor blade.

In a particularly preferred embodiment, the second coating contains polymer particles. In this case, the polymer particles advantageously contain polytetrafluoroethylene (PTFE) and, in particular, have a particle size of 0.5-1 μm. Apart from unavoidable impurities, the polymer particles advantageously consist entirely of polytetrafluoroethylene.

In particular, polymer particles in the second coating can have a lubricating effect, which in turn improves the sliding properties of the working edge of the doctor blade during the doctoring-off operation. In this respect, polymer particles comprising polytetrafluoroethylene, and very particularly polymer particles which consist entirely of polytetrafluoroethylene, have proved to be particularly advantageous in particular given a particle size of 0.5-1 μm. Particularly in connection with a nickel-phosphorus alloy having a phosphorus content of 6-9%, such polymer particles contribute to providing a high-quality working edge, which makes extremely precise doctoring off that preserves a printing cylinder and/or a printing roll possible.

In principle, polymer particles which contain polytetrafluoroethylene can also contain additional polymer materials. It is likewise possible to use polymer particles without polytetrafluoroethylene or to provide particle sizes of less than 0.5 or more than 1 μm. It is also possible to dispense with polymer particles completely in the second coating. In this case, however, at least some of the advantages mentioned above are not obtained.

In order to produce a doctor blade, in particular a doctor blade according to the invention, a first coating on the basis of a nickel-phosphorus alloy can be deposited on a working edge region of the doctor blade formed in a longitudinal direction of a flat and elongated main body. In this case, monocrystalline and/or polycrystalline diamond particles having a particle size of at least 5 nm and less than 50 nm are dispersed in the first coating.

The first coating is advantageously deposited by an electroless deposition or coating process. In this case, no electrical current is used for the deposition of the first coating on the basis of a nickel-phosphorus alloy, as a result of which such deposition processes clearly differ from the electrodeposition techniques. For the electroless deposition or coating, the working edge or, if appropriate, the main body of the doctor blade as a whole is dipped into a suitable electrolyte bath with monocrystalline and/or polycrystalline diamond particles suspended therein and coated in a manner known per se. The monocrystalline and/or polycrystalline diamond particles suspended in the electrolyte bath are incorporated into the nickel-phosphorus alloy during the coating or deposition process, and are thereby dispersed in the deposited nickel-phosphorus alloy in a substantially random distribution. Owing to the relatively small particle size of at least 5 nm and less than 50 nm, and the relatively high surface to volume ratio associated therewith, the diamond particles are distributed uniformly in the entire electrolyte solution, despite their considerable density. Since the frictional forces which occur between the surface of the diamond particles and the liquid in the electrolyte bath are generally greater than the gravitational force which acts on the diamond particles, slipping of the diamond particles during the deposition process is specifically largely prevented. Finally, this also results in an extremely uniform incorporation of the diamond particles into the first coating.

An electroless deposition process therefore makes it possible to produce a high-quality first coating which, in particular, has a high degree of contour accuracy with respect to the working edge of the doctor blade or with respect to the main body of the doctor blade and also a very uniform layer thickness distribution. In other words, the electroless deposition forms an extremely uniform nickel-phosphorus alloy with particularly uniformly distributed monocrystalline and/or polycrystalline diamond particles, which follows the contour of the working edge of the doctor blade or the main body in an optimum manner, and this makes a significant contribution to the quality of the doctor blade.

Owing to the electroless deposition of the nickel-phosphorus alloy, it is also possible in principle for plastics to be used as the main body for the doctor blade and to be provided in a simple manner with the first coating consisting of the nickel-phosphorus alloy.

In principle, however, it is also conceivable to deposit the first coating on the main body by means of an electroplating process. However, it has been found that first coatings deposited in this manner have a less uniform form and overall have reduced stability and adhesion to the main body.

If a second coating on the basis of a further nickel-phosphorus alloy is applied to the first coating, this can be deposited both by an electroless coating process and by an electroplating process. Particularly for the deposition of a second coating on the basis of a further nickel-phosphorus alloy with polymer particles dispersed therein, however, the electroless deposition has proved to be particularly suitable.

It is further preferable for the first coating to be subjected to heat treatment for hardening purposes, in particular at a temperature of 100-500° C., in particular 170-300° C. If present, the second coating is also advantageously subjected to the heat treatment. The heat treatment induces solid-state reactions in the nickel-phosphorus alloys, which increase the hardness of the nickel-phosphorus alloys in the first coating, and if appropriate also in the second coating. In this case, the temperatures of 100-500° C., in particular 170-300° C., are preferably maintained for a holding time of 0.5-15 hours, particularly preferably 0.5-8 hours. Such temperatures and holding times have proved to be ideal for achieving sufficient hardnesses of the nickel-phosphorus alloys.

In this respect, temperatures of less than 100° C. are likewise possible. In this case, however, very long and largely uneconomical holding times are required. Depending on the material of the main body, temperatures of higher than 500° C. are also feasible, in principle, but in this case the hardening process of the nickel-phosphorus alloy is harder to control.

In principle, however, it is also possible to dispense completely with heat treatment. However, this is at the expense of the wear resistance or service life of the doctor blade.

If two coatings are arranged on the main body, the heat treatment is advantageously carried out only after the deposition or the application of the second coating on the first coating. As a result, oxide formation is prevented in particular on the surface of the first coating, which is covered by the second coating. This firstly entails better adhesion between the first coating and the second coating, and secondly the uniformity of the doctor blade in the region of the working edge is improved as a whole.

If a second coating is provided, this is deposited, in particular, on all sides of a lateral surface region of the main body that is present with regard to the longitudinal direction, in particular the entire main body. In this case, the lateral surface region of the main body that is present with regard to the longitudinal direction, or preferably the entire main body, is covered on all sides with the second coating. Apart from the fact that the main body of the doctor blade is therefore protected optimally against environmental influences and, in particular, the sometimes chemically aggressive printing inks, the coating operation is thereby simplified. By way of example, the main body can be dipped completely into the electrolyte bath. This is not possible when exclusively the working edge provided with the first coating is coated, since the main body then has to undergo complex orientation with respect to the surface of the liquid in the electrolyte bath in certain circumstances.

In principle, however, it is also possible for merely the working edge provided with the first coating to be provided with the second coating.

Further advantageous embodiments and combinations of features of the invention will become apparent from the following detailed description and from the totality of the patent claims.

### BRIEF DESCRIPTION OF THE ACCOMPANYING DRAWINGS

The drawings used to explain the exemplary embodiment show:

FIG. 1 is a cross section through a first lamellar doctor blade according to the invention with a coating in the region of the working edge;

FIG. 2 is a cross section through a second lamellar doctor blade according to the invention with a two-fold coating in the region of the working edge; and

FIG. 3 is a schematic illustration of a process for producing a doctor blade.

### DETAILED DESCRIPTION OF THE PREFERRED EMBODIMENTS

In principle, identical parts are provided with the same reference signs in the figures.

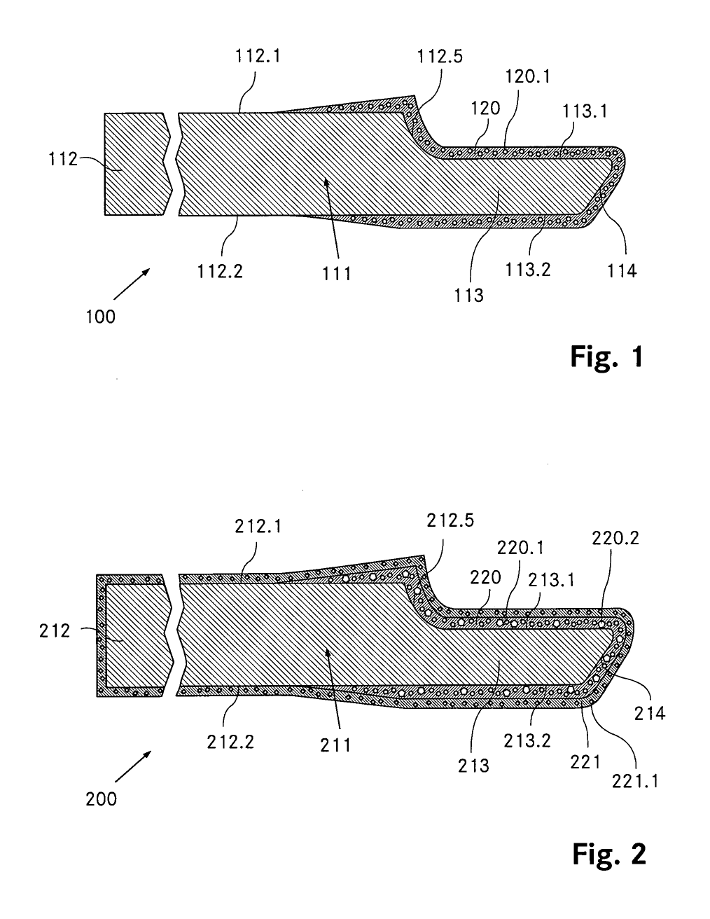

FIG. 1 shows a first lamellar doctor blade 100 according to the invention in cross section. The lamellar doctor blade 100 contains a steel main body 111, which, on the left-hand side in FIG. 1, has a rear region 112 with a substantially rectangular cross section. The thickness of the doctor blade, measured from the top side 112.1 to the bottom side 112.2 of the rear region, is about 0.2 mm. The length of the main body 111 or of the lamellar doctor blade 100, as measured perpendicularly to the plane of the drawing, is 1000 mm, for example.

On the right-hand side in FIG. 1, the main body 111 tapers off in a steplike manner from the top side 112.1 of the rear region 112 in order to form a working edge region 113 or a working edge. A top side 113.1 of the working edge 113 lies on a plane below the plane of the top side 112.1 of the rear region 112, but is formed substantially parallel or plane-parallel to the top side 112.1 of the rear region 112. A concavely shaped transition region 112.5 is present between the rear region 112 and the working edge 113. The bottom side 112.2 of the rear region 112 and the bottom side 113.2 of the working edge 113 lie in a common plane, which is formed plane-parallel to the top side 112.1 of the rear region 112 and plane-parallel to the top side 113.1 of the working edge 113. The width of the main body 111, measured from the free end of the rear region to the end face 114 of the working edge 113, measures 40 mm, for example. The thickness of the working edge 113, measured from the top side 113.1 to the bottom side 113.2 of the working edge, is 0.060-0.150 mm, for example, which corresponds approximately to half the thickness of the doctor blade in the rear region 112. The width of the working edge region 113, measured on the top side 113.1 of the working edge 113 from the end face 114 to the transition region 112.5, is 0.8-5 mm, for example.

A free end face 114 at the free end of the working edge 113 on the right extends obliquely to the left and downward from the top side 113.1 of the working edge 113 toward the bottom side 113.2 of the working edge 113. In this case, the end face 114 is at an angle of about 45° and 135°, respectively, with regard to the top side 113.1 of the working edge 113 and with regard to the bottom side 113.2 of the working edge 113. A top transition region between the top side 113.1 and the end face 114 of the working edge 113 is rounded off. Similarly, a bottom transition region between the end face 114 and the bottom side 113.2 of the working edge 113 is rounded off.

Furthermore, the working edge 113 of the lamellar doctor blade 100 is surrounded by a first coating 120. In this case, the first coating 120 completely covers the top side 113.1 of the working edge 113, the concavely shaped transition region 112.5 and an adjoining partial region of the top side 112.1 of the rear region 112 of the main body 111. Similarly, the first coating 120 covers the end face 114, the bottom side 113.2 of the working edge 113 and a partial region, adjoining the bottom side 113.2 of the working edge 113, of the bottom side 112.2 of the rear region 112 of the main body 111.

By way of example, the first coating 120 comprises an electrolessly deposited nickel-phosphorus alloy having a phosphorus content of 10% by weight, for example. Polycrystalline diamond particles 120.1 having a particle size of, for example, 15-40 nm are dispersed therein. The volume proportion of the polycrystalline diamond particles 120.1 is 18%, for example. In the region of the working edge 113, the layer thickness of the first coating 120 measures 5 μm, for example. The layer thickness of the first coating 120 decreases continuously in the region of the top side 112.1 and of the bottom side 112.2 of the rear region 112, such that the first coating 120 peters out in the form of a wedge in a direction away from the working edge 113.

FIG. 2 shows a further lamellar doctor blade 200 according to the invention in cross section. The lamellar doctor blade 200 contains a steel main body 211, which is designed substantially identically to the main body 111 of the first lamellar doctor blade 100 shown in FIG. 1.

The working edge 213 of the second lamellar doctor blade 200 is surrounded by a first coating 220. In this case, the first coating 220 completely covers the top side 213.1 of the working edge 213, the transition region 212.5 and an adjoining partial region of the top side 212.1 of the rear region 212 of the main body. Similarly, the first coating 220 covers the end face 214, the bottom side 213.2 of the working edge 213 and a partial region, adjoining the bottom side 213.2 of the working edge 213, of the bottom side 212.2 of the rear region 212 of the main body 211.

By way of example, the first coating 220 of the second lamellar doctor blade 200 consists essentially of an electrolessly deposited nickel-phosphorus alloy having a phosphorus content of 12% by weight, for example. Polycrystalline diamond particles 220.1 (symbolized by circles in FIG. 2) and hard material particles 220.2 of aluminum oxide (Al₂O₃) (symbolized by pentagons in FIG. 2) are dispersed in the first coating. In this case, the diamond particles 220.1 have a particle size of, for example, 15-40 nm, whereas the hard material particles 220.2 or the particles of aluminum oxide have a particle size of 0.4 μm. The volume proportion of the polycrystalline diamond particles 220.1 is 15%, for example. In the region of the working edge 213, the layer thickness of the first coating 220 measures 5 μm, for example. The layer thickness of the first coating 220 decreases continuously in the region of the top side 212.1 and of the bottom side 212.2 of the rear region 212, such that the first coating 220 peters out in the form of a wedge in a direction away from the working edge 213.

The first coating 220 and the remaining regions of the main body 211 which are not covered by the first coating 220 are surrounded completely by a second coating 221. As a result, the top side 212.1 and the bottom side 212.2 of the rear region 212 and also the rear end face of the main body 211 are also covered with the second coating 221. The lateral surface region of the main body 211 with regard to the longitudinal direction of the main body 211 or of the second doctor blade 200, lying perpendicular to the plane of the drawing, is therefore surrounded completely and all around by at least one of the two coatings 220, 221. The front and rear side faces of the main body 211, which lie plane-parallel to the plane of the drawing and are not visible in FIG. 2, can likewise be covered with the second coating 221.

The second coating 221 consists of a further electrolessly deposited nickel-phosphorus alloy having a phosphorus content of about 7%. The phosphorus content of the first coating 210 is therefore higher than the phosphorus content of the second coating 220. The layer thickness of the second coating 221 is 1.8 μm, for example. Polymer particles 221.1 are additionally dispersed in the second coating 221. By way of example, the polymer particles 221.1 consist of polytetrafluoroethylene (PTFE) and have a particle size of, for example, 0.6-0.8 μm.

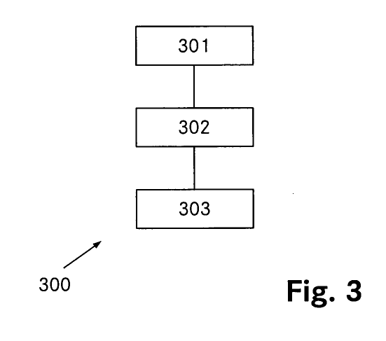

FIG. 3 schematically shows a process 300 for producing a doctor blade, as shown in FIGS. 1 and 2, for example. In this process, in a first step 301, the working edges 113, 213 of the main bodies 111, 211 which are to be coated are dipped into a suitable aqueous electrolyte bath, known per se, with polycrystalline and/or monocrystalline diamond particles 120.1, 220.1 having a particle size of, for example, 10-40 nm suspended therein. If, as in the case of the lamellar doctor blade shown in FIG. 2, additional hard material particles 220 are to be incorporated into the coating, the additional hard material particles 220 are likewise suspended in the electrolyte bath. During the subsequent deposition process, nickel ions inter alia from a nickel salt, e.g., nickel sulfate, are reduced by a reducing agent, e.g., sodium hypophosphite, in an aqueous environment to form elemental nickel and are deposited on the working edges 113, 213, with the formation of a nickel-phosphorus alloy and with embedding of the polycrystalline and/or monocrystalline diamond particles 120.1, 220.1 and also, if present, the additional hard material particles 220.2. This takes place without the application of an electrical voltage or completely electrolessly under moderately acidic conditions (pH 4-6.5) and at elevated temperatures of 70-95° C., for example. The phosphorus content in the first coatings 120, 220 can be controlled in a manner known per se by the concentrations and mixing ratios of the reagents in the electrolyte bath.

If, as in the case of the second lamellar doctor blade 200 shown in FIG. 2, a second coating 220 is additionally provided, in a second step 302 the main body 211 with the first coating 210 is dipped into a further aqueous electrolyte bath, known per se, with polymer particles 220.1, e.g., of polytetrafluoroethylene having a particle size of 0.6-0.8 μm, suspended therein. The subsequent deposition process proceeds in the same way as that already described for the first step 301 for the first coatings 120, 220. If, as in the case of the first lamellar doctor blade shown in FIG. 1, no second coating is provided, the second step 302 is omitted and, if desired, the third step 303 is carried out directly.

In a third step 303, the coated main bodies 111, 211 are fed for heat treatment over the course of two hours, for example, and at a temperature of 300° C. The first coatings 120, 220 and, if present, the second coating 221 are thereby hardened. Finally, the finished lamellar doctor blades 100, 200 are cooled and are thus ready for use.

Tests have shown that the first lamellar doctor blade 100 shown in FIG. 1 has a very high wear resistance and stability throughout its service life. For comparison purposes, in a first comparative test, the introduction of diamond particles 120.1 into the first coating 120 was dispensed with in the case of a lamellar doctor blade as shown in FIG. 1. In this case, it was found that such doctor blades without diamond particles have a reduced wear resistance and accordingly shorter service lives compared to the lamellar doctor blade 100 according to the invention shown in FIG. 1.

In a second comparative test, instead of using the diamond particles 120.1 having a particle size of about 10-40 nm, larger diamond particles having a particle size of about 100 nm were used in the case of a lamellar doctor blade as shown in FIG. 1. In this case, however, the working edge of the doctor blade was less stable, as considered throughout the service life of the doctor blade, than in the case of the lamellar doctor blade 100 shown in FIG. 1.

In further tests, the second lamellar doctor blade 200 shown in FIG. 2 proved in part to be even more stable and more wear-resistant compared to the first lamellar doctor blade 100.

The embodiments and the production processes described above are to be understood merely as illustrative examples, which can be modified as desired within the scope of the invention.

By way of example, the main body 111, 211 shown in FIGS. 1 and 2 may also be produced from a different material, e.g., stainless steel or a carbon steel. In this case, it may be advantageous for economical reasons to apply the second coating 221 merely in the region of the working edge 213 in order to reduce the consumption of material for the coating. In principle, however, the main body 111, 211 can also consist of a non-metallic material, e.g., plastics. This may be advantageous, in particular, for applications in flexographic printing.

However, it is also possible to use main bodies having different shapes instead of the main bodies 111, 211 shown in FIGS. 1 and 2. In particular, the main bodies may have a wedge-shaped working edge or a non-tapered cross section with a rounded-off working edge. The free end faces 114, 214 at the free ends of the working edges 113, 213 on the right may also have a completely rounded-off shape, for example.

Furthermore, the doctor blades 100, 200 according to the invention shown in FIGS. 1 and 2 can also have different dimensions. Thus, by way of example, the thicknesses of the working regions 113, 213, measured from the top sides 113.1, 213.1 to the bottom sides 113.2, 213.2 of the working regions 113, 213, may vary in a range of 0.040-0.200 mm.

Similarly, all the coatings 120, 220, 221 of the two lamellar doctor blades 100, 200 may contain further alloy components and/or additional substances, e.g., metal atoms, nonmetal atoms, inorganic compounds and/or organic compounds.

It is additionally also within the scope of the invention to omit the second coating 221 for the second lamellar doctor blade 200, such that merely the first coating 210 with diamond particles 220.1 and hard material particles 220.2 dispersed therein is present on the main body 211.

In the case of the two lamellar doctor blades 100, 200 shown in FIGS. 1 and 2, it is also possible to surround the lateral surface regions of the main bodies 111, 211 with regard to the longitudinal direction of the main bodies 111, 211, lying perpendicular to the plane of the drawing, completely and all around with the first coatings 120, 220.

In summary, it can be stated that a novel doctor blade design has been found, which entails a high wear resistance and stability of the doctor blade. In particular, the doctor blades according to the invention make more accurate wiping off possible, in particular of printing ink on printing cylinders or printing rolls, throughout their service life.

While the method herein described, and the form of apparatus for carrying this method into effect, constitute preferred embodiments of this invention, it is to be understood that the invention is not limited to this precise method and form of apparatus, and that changes may be made in either without departing from the scope of the invention, which is defined in the appended claims.

What is claimed is:

1. A doctor blade, in particular for doctoring off printing ink from a surface of a printing form and/or for use as a paper doctor knife, comprising a flat and elongated main body having a working edge region formed in a longitudinal direction, wherein at least the working edge region is covered with a first coating on the basis of a nickel-phosphorus alloy, whereas monocrystalline and/or polycrystalline diamond particles are dispersed in the first coating, wherein the particle size of the diamond particles measures at least 5 nm and less than 50 nm.

2. The doctor blade as claimed in claim 1, whereas the phosphorus content of the nickel-phosphorus alloy in the first coating is 7-12% by weight.

3. The doctor blade as claimed in claim 1, whereas the layer thickness of the first coating is 1-10 μm.

4. The doctor blade as claimed in claim 1, whereas the volume density of the diamond particles in the first coating is 5-20%, in particular 15-20%.

5. The doctor blade as claimed in claim 1, whereas additional hard material particles are present in the first coating.

6. The doctor blade as claimed in claim 5, whereas the additional hard material particles comprise aluminum oxide particles having a particle size of 0.3-0.5 μm.

7. The doctor blade as claimed in claim 1, whereas a second coating on the basis of a further nickel-phosphorus alloy is arranged on the first coating.

8. The doctor blade as claimed in claim 7, whereas the phosphorus content of the further nickel-phosphorus alloy of the second coating is 6-9% by weight.

9. The doctor blade as claimed in claim 7, whereas the layer thickness of the second coating measures 0.5-3 μm.

10. The doctor blade as claimed in claim 7, whereas the second coating contains polymer particles.

11. The doctor blade as claimed in claim 10, whereas the polymer particles contain polytetrafluoroethylene.

12. A process for producing a doctor blade, wherein a first coating on the basis of a nickel-phosphorus alloy is deposited on a working edge region of the doctor blade formed in a longitudinal direction of a flat and elongated main body, whereas monocrystalline and/or polycrystalline diamond particles having a particle size of at least 5 nm and less than 50 nm are dispersed in the first coating.

13. The process as claimed in claim 12, whereas the first coating is deposited by an electroless coating process.

14. The process as claimed in claim 12, whereas a second coating on the basis of a further nickel-phosphorus alloy, preferably with polymer particles dispersed therein, is deposited on the first coating.

15. The process as claimed in claim 12, whereas the first coating is subjected to heat treatment for hardening purposes.

16. The use of a doctor blade as claimed in claim 1 for doctoring off printing ink from a surface of a printing form, in particular a printing form for flexographic printing, gravure printing and/or decorative gravure printing.

17. The doctor blade as claimed in claim 10, whereas the polymer particles have a particle size of 0.5-1 μm.

18. The process as claimed in claim 15, whereas the first coating is subjected to heat treatment at a temperature of 100-500° C., in particular 170-300° C.
